(19) United States
(12) Patent Application Publication
(10) Pub. No.: US 2025/0365817 A1
(43) Pub. Date: Nov. 27, 2025

(54) ELECTRIC HEATER

(71) Applicant: UOP LLC, Des Plaines, IL (US)

(72) Inventors: Aziz Sattar, Itasca, IL (US); Raymond E. Tucker, Derby, NY (US); Phillip F. Daly, Palatine, IL (US); Gregory R. Werba, Arlington Heights, IL (US)

(21) Appl. No.: 19/070,192

(22) Filed: Mar. 4, 2025

Related U.S. Application Data
(60) Provisional application No. 63/651,721, filed on May 24, 2024.

(51) Int. Cl. H05B 3/00; H05B 3/40

(52) U.S. Cl. CPC H05B 3/0004; H05B 3/40

(57) ABSTRACT

Electric heating elements are described. The electric heating elements can be electrical resistance heated elements or electrical impedance heated elements. The electric heating elements have a heat transfer enhancement structure on the surface and/or may be at least partially made from a porous metal. Electric heaters incorporating the electric heating elements and methods of heating a fluid process streams are also described.

### RELATED APPLICATIONS

This application claims priority to U.S. Provisional Patent Application Ser. No. 63/651,721, filed on May 24, 2024, the entirety of which is incorporated herein by reference.

### BACKGROUND OF THE INVENTION

There is increased focus on reducing fossil fuel consumption, improving efficiencies to reduce carbon dioxide footprint, and increasing dependency on renewable sources of energy. With the pivoting of the refining and petrochemical industries towards sustainable sources of energy like solar, wind, hydroelectric, nuclear, etc. and the making of more green electricity available, there is a desire to reduce the size of fired heaters for technologies like hydrocarbon reforming, dehydrogenation, isomerization, transalkylation, hydrotreating, steam production, and others.

Process heating of a feed stream is generally done by fired heating or by circulation of hot heat transfer fluid in contact with metallic conduit/vessel/pipe containing the pressurized feed. This heating itself generates carbon dioxide from combustion of hydrocarbon rich fuel gas There are many thermal resistances to efficient heat transfer between the heating sources and feed to be heated. In case of fired heating, only 60% of thermal energy generated by combustion is transferred to process feed. Fired heating can also create hot spots as heat flux imparted to metallic conduit/vessel/pipe containing the pressurized feed is often non-uniform heat due to proximity of flame front and conduit/vessel/pipe. The hot spot in metallic conduit/vessel/pipe can increase potential of metal catalyzed coking of feed. Other consequences of hot spots may include local fouling, polymerization, and cracking, which are also problems for the refining and petrochemical industries. Additionally, fired heating itself generates carbon dioxide from combustion of hydrocarbon rich fuel gas.

Recently, the use of electric heaters in hydrocarbon processing has been proposed. While presumably effective for their intended purposes, it is believed that newer and better heater designs will increase the effectiveness and efficiency of the electric heaters in hydrocarbon processing processes.

Thus, the present invention provides devices and processes which provide more effective and efficient ways to heat process streams with electric heaters.

### BRIEF DESCRIPTION OF THE DRAWINGS

FIG. 1 is a graph illustrating pool boiling regions.

FIG. 2 is a graph illustrating the boiling enhancement objective.

FIG. 3 is an illustration of one embodiment of an electric steam boiler system.

FIG. 4 is an illustration of one embodiment of an electrical reboiler in a chemical process.

FIGS. 5A-5D are illustrations of different embodiments of dendritic heat transfer enhancement structures.

FIGS. 6A-6B are illustrations of different embodiments of mesh layer heat transfer enhancement structures.

FIG. 7 is an illustration of a porous particle coating.

FIG. 8 is an illustration of a resistive heating element.

FIG. 9 is an illustration of an impedance heating element.

FIG. 10 is an illustration of an impedance heating plate.

FIGS. 11A and 11B are illustrations of one embodiment of an azimuthally varying thermal resistance enhanced resistive heating element.

FIG. 12A is an illustration of one embodiment of an enhanced non-circular resistive heating element with azimuthally varying thermal resistance around a heating substrate.

FIG. 12B is an illustration of one embodiment of an enhanced circular resistive heating element with non-circular heating substrate thermal resistance.

FIG. 13 is an illustration of one embodiment of a heat transfer enhancement structure with fluid-philic and fluid phobic areas.

### DESCRIPTION

Immersion type electric heaters used in refining and petrochemical processes are limited by the heating element temperatures, and correspondingly, the sheath temperatures that are reached. For a given heat flow or heat duty (or heat flux (heat flow per unit surface area)), once the size of the heater is determined, the element temperature is directly a function of the heat transfer coefficient (HTC) of the flow over the elements. The HTC is a function of the process fluid properties, the flow rate and velocities, and the type of heat transfer (i.e., the flow phases present), and the heat flux of the heating elements.

For electrical resistance heating elements, high element temperatures can cause early failure of the heating elements because the internal resistance wire gets too hot and burns out. For certain process applications, high element temperatures may result in fouling, coking, polymerization, gumming, etc., which further increase the element temperatures. For these reasons, the heat flux is limited to maintain acceptable element temperatures.

Traditionally, these heat flux considerations have limited the use of electric heaters because there are more cost-effective approaches to heating process fluids, such as steam heating, hot oil heating, and radiant heating in fired process heaters.

The present invention takes advantage of low carbon intensity electric power to power an electric heater/boiler. Electric heaters for boiling service are available in which bare heating elements are submerged into a fluid to provide heat for boiling the fluid. Bare heating wire heaters often operate above 1600° F. which may be too hot for a heat sensitive fluid. Sheathed heating elements may be employed when heat sensitive fluids are to be boiled.

An existing sheathed heating element electrical boiler may be installed into a fixed shape (ID, length) nozzle, horizontal kettles or reboilers. When increased capacity is needed, additional boiling duty may be required, and thus a larger heating element surface area. The existing nozzle, horizontal kettles or reboilers may be insufficient to accommodate the larger surface area.

It is desirable to maintain the most compact shape factor possible due to constraints from available plot space, the fixed shape of the existing nozzle, kettle, or vessel, or the desire to minimize the capital expense of a new vessel into which a sheathed electrical boiler must be inserted.

Currently, there is a move toward reducing the carbon footprint of chemical processes. One method of doing so would be to replace fuel fired heating equipment with electrically powered equipment using renewable or waste energy generated electricity.

Thus, there is a need to improve the design and applicability of electric heaters in a variety of process applications. One way to increase the use of electric heaters is through improving the heat transfer coefficient (HTC) through modification of the surface of the heating elements. Traditionally, modifying the surface of heating elements has not been done.

Tubing with a porous particle layer is typically known to provide 2-3 times improvement in the overall heat transfer coefficient when used in shell and tube applications. In an electric heater using the present invention, the expected benefit to a boiling heat transfer coefficient is 20-30 times that of a bare surface heater element. The benefit to the electric heater is higher because the overall heat transfer coefficient is not limited by the film heat transfer coefficient of the heating fluid source.

The present invention involves a boiler or heater comprising a plurality of electric heating elements. The electric heating elements can be electrical resistance heating elements or electrical impedance heating elements. The electric heating elements have a heat transfer enhancement structure on the surface and/or a porous metal layer on the surface (e.g., a porous metal layer on the surface of solid metal which is contact with the fluid being heated). The heat conducting outer surface may comprise a sheath comprising a non-porous, hollow tube having a heat transfer enhancement structure thereon; or a sheath comprising a non-porous hollow tube with a porous a metal layer thereon, with an optional heat transfer enhancement structure thereon; or a solid flat plate having a heat transfer enhancement structure thereon, or a solid flat plate with a porous metal layer thereon, with an optional heat transfer enhancement structure thereon.

The electrical resistance heated element comprises a heat generating substrate, a dielectric packing material surrounding the heat generating substrate, and a heat conducting outer surface. The heat conducting outer surface can be a sheath with the heat transfer enhancement structure on it, or a sheath with a porous metal layer that functions as a heat transfer enhancement structure. The sheath protects the dielectric packing material surrounding the heat generating substrate from the process fluid. Alternatively, the heat conducting outer surface can be a solid flat plate having a heat transfer enhancement structure thereon, or a solid flat plate with a porous metal layer thereon, with an optional heat transfer enhancement structure thereon. The electrical impedance heated element comprises a solid rod having a heat transfer enhancement structure on a heat conducting outer surface thereof; or a non-porous, hollow tube having a heat transfer enhancement structure on a heat conducting inner or outer surface thereof; or a porous, hollow tube with an optional heat transfer enhancement structure on a heat conducting inner or outer surface thereof; or a solid flat plate having a heat transfer enhancement structure on heat conducting surface thereof; or a porous, flat plate with an optional heat transfer enhancement structure on heat conducting surface thereof.

The heat transfer enhancement structure can be coated with a porous metal layer or a matrix that is attached to a heat conducting inner or outer surface depending on the type of heating element.

Saturated liquid is drawn into the porous layer or matrix by capillary action and vaporizes from the extremely large number of cavities or pores that function as ideal nucleation sites for the generation vapor bubbles.

The extremely active boiling surface tends to keep particulate matter from settling on or within the heat transfer enhancement structure This reduces fouling potential and yields extended runtime before cleaning in place is needed.

A combination of good thermal conductivity of the porous layer or matrix, highly extended micro-surface area, and large numbers of re-entrant sites can result in boiling heat-transfer coefficients (HTC) that are 10-30 times greater than a bare surface heating element and keeps the element well wetted, helping to avoid dry out, over heating, fouling, coking, etc. The larger HTC will allow for reduced surface area of the electric heating elements for the same amount of heating and make for a more compact shape factor or increase the amount of heating for the same surface area.

The significant improvement in the HTC permits reducing both the size of the bundle and the temperature of the elements. In addition, the limiting relationship between velocity over the element and the heat transfer coefficient of the element is reduced or eliminated because the enhancement is not flow dependent. There are also wetting properties to the porous particle layer coating that may improve the performance in situations where the elements are not totally submerged in the boiling liquid. These characteristics expand the design possibilities for electric heater bundles and increase the process applications where they can be used.

The heat transfer enhancement structure increases the achievable heat flux of the reboiler bundle, which significantly reduces the size, while also decreasing the element temperatures, which enables the use of electric heaters in applications that would otherwise not be practical or possible. The lower temperatures greatly reduce the possibility of element failure, increase element life, reduced fouling, and allow metallurgies other than stainless steel and higher alloys.

Electrical resistance heating elements generally use 304 stainless steel or higher alloy sheaths due to the typical operating temperatures. However, for some less common low temperature services, carbon steel elements have been produced. The use of the heat transfer enhancement structure or a porous metal layer on the sheath or tube reduces the element temperature so that carbon steel element sheaths or tubes may be used in the boiling services found in refining and petrochemical applications.

One aspect of the invention is an electric heating element. In one embodiment, the electric heating element comprises: an electrical resistance heating element or an electrical impedance heating element. The electrical resistance heated element comprises a heat generating substrate; a dielectric packing material surrounding the heat generating substrate; and a heat conducting outer surface. The heat conducting outer surface may comprise a sheath comprising a non-porous, hollow tube having a heat transfer enhancement structure thereon, or a sheath comprising a porous, hollow tube with an optional heat transfer enhancement structure thereon. The electrical impedance heated element comprises: a solid rod having a heat transfer enhancement structure on a heat conducting outer surface thereof, or a non-porous, hollow tube having a heat transfer enhancement structure on a heat conducting inner or outer surface thereof, or it may be a porous, hollow tube. The porous, hollow tube may have an optional heat transfer enhancement structure on the heat conducting inner or outer surface thereof.

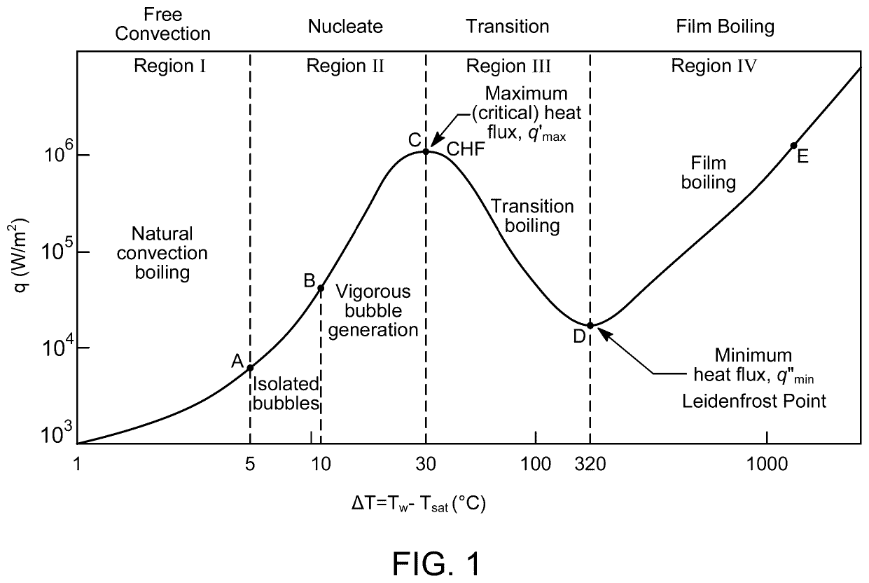

FIG. 1 shows a log-log plot of heat flux generated by the surface versus temperature difference between bulk fluid and heat surface. The shape of the pool boiling curve, and the transition points from one boil regime to another, depends on the surface structure and its shape. FIG. 1 shows the boiling curve for a plain (unenhanced) single smooth tube as the surface is heated. Region I is the natural free-convection boiling region, Region II is the nucleate boiling region, Region III is the transition boiling region, and Region IV is the fully developed film boiling region. Isolated bubbles first appear at Point A, which is the transition from natural convection boiling to the onset of nucleate boiling (ONB). Vigorous and continuous bubble generation occurs at point B in the nucleate boiling region. Slugs and columns appear at Point B in the nucleate boiling region. Point C is the maximum heat flux (q'max), marking the critical heat flux (CHF) and the transition point from the nucleate boiling regime to the transition boiling regime. Point D is the minimum heat flux (q'min) to sustain film boiling. Point D is commonly known as the Leidenfrost Point. The curve line between Point D and Point E represents film boiling regime. The CHF is the point where bubbles start to cover the heating surface completely, preventing liquid from contacting it directly and drastically reducing the heat transfer rate. This leads to an increase in the surface temperature of the heat conducting surface.

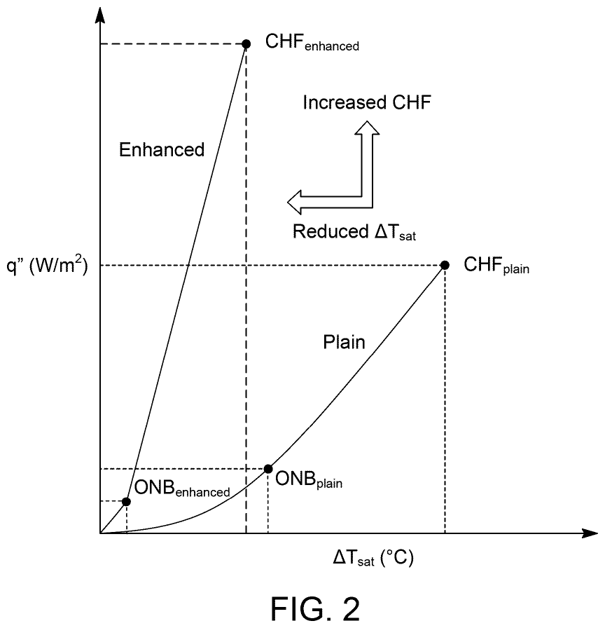

FIG. 2 is a graphical representation showing benefits that boiling surface enhancement has on the pool boiling curve. For an enhanced surface, the increased CHF allows more heat to be removed from a heated surface by a boiling liquid. The enhanced surface also decreases the boiling ΔT, reducing the surface temperature. The increase in the number of bubble nucleation sites and more efficient bubble departure from the surface enabled by surface enhancement leads to greater heat transfer and thus a lower surface temperature at a given heat flux. This effectively reduces the superheat needed to initiate onset of boiling.

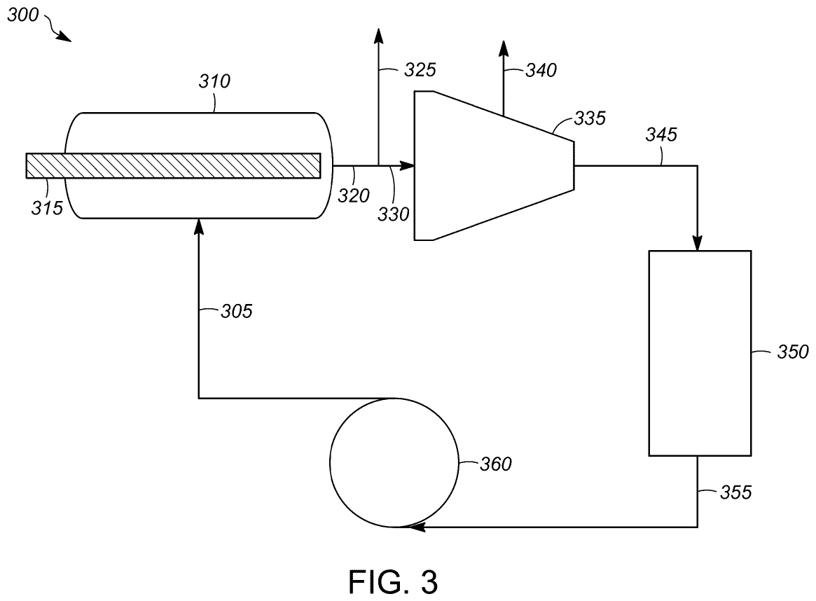

FIG. 3 is a process diagram for one embodiment of a steam power plant 300. Water stream 305 enters boiler 310 which includes heating elements 315. The water is converted into steam which exits the boiler as steam stream 320. Steam stream 320 is divided into high pressure steam stream 325 and high pressure steam stream 330. Steam stream 325 can be used in another process, for example, heating a fluid. Steam stream 330 is sent to steam turbine 335 where the high pressure steam is converted to mechanical power 340. Low pressure steam stream 345 exits the steam turbine 335 and is sent to condenser 350. The condensed water stream 355 is sent to pump 360 and returned to the boiler 310.

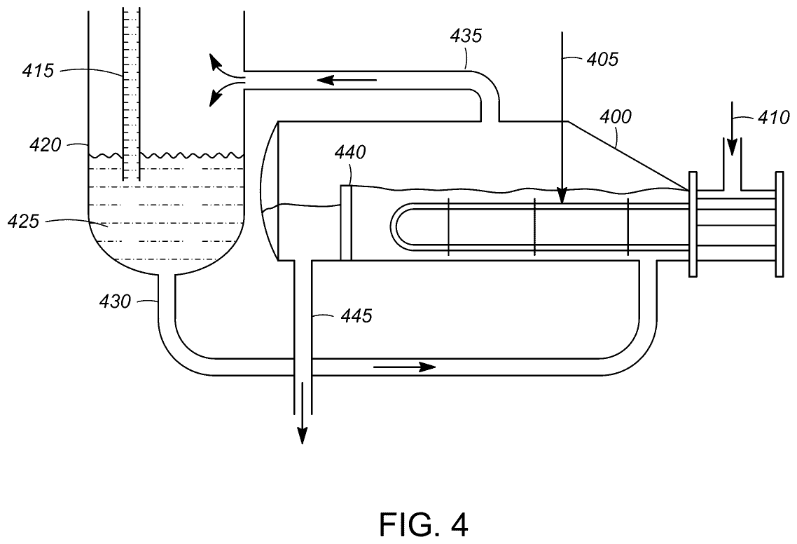

FIG. 4 is a diagram of one embodiment showing the operation of a horizontal kettle reboiler 400. The kettle reboiler 400 includes electric heating element 405. The electric heating element 405 are supplied with electric power 410. The downcomer 415 from the bottom tray (not shown) of the distillation column 420 send liquid 425 to the bottom of the distillation column 420. The liquid exits the distillation column 420 as liquid bottoms stream 430. The liquid bottoms stream 430 from distillation column 420 is sent to the kettle reboiler 400 where a portion is heated to the vapor phase. The vapor exits the kettle reboiler 400 as vapor stream 435 which is then returned to the distillation column 420. Weir 440 maintains the liquid level in the kettle reboiler 400. When the liquid level exceeds the height of the weir 440, the excess liquid flows over the weir 440 and exits the kettle reboiler as bottoms stream 445.

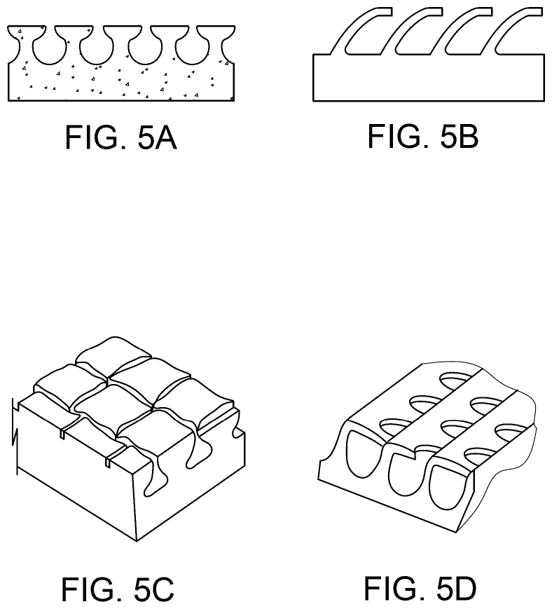

FIGS. 5A-5D illustrate four examples of dendritic boiling enhancements.

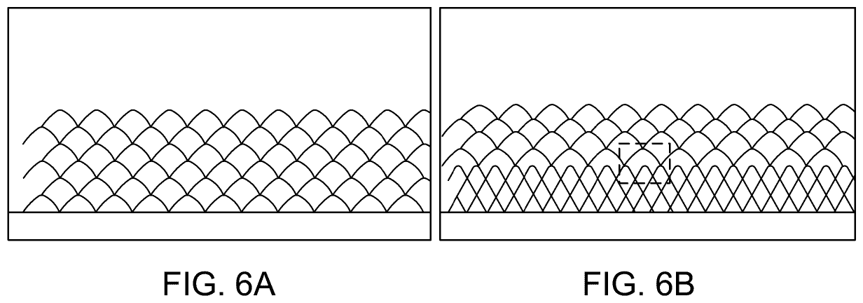

FIGS. 6A-6B illustrate two examples of mesh boiling enhancements. FIG. 6A shows a mesh with uniform porosity, while FIG. 6B shows mesh with a gradient porosity.

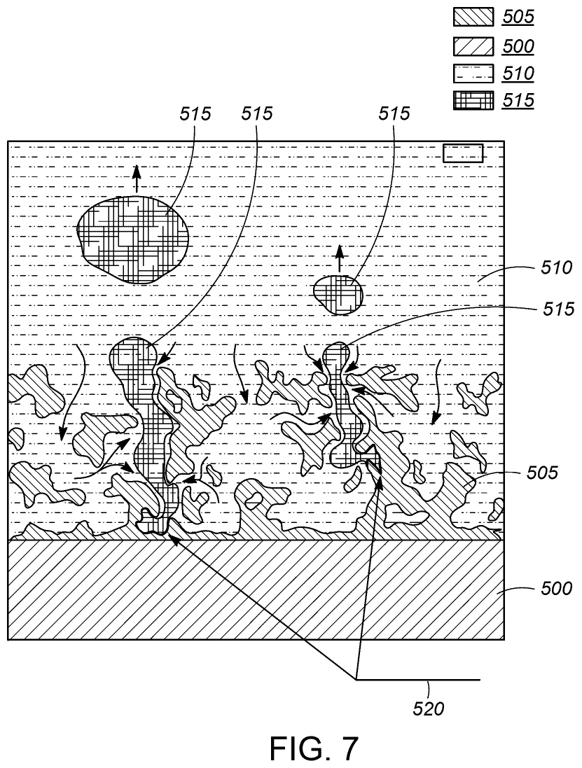

FIG. 7 illustrates an example of a porous particle coating. Metal powder particles deposited on a surface form porous coatings with numerous cavities which can promote nucleation of bubble generation in boiling processes and thus enhance boiling heat transfer enhancement. There is a porous matrix 505 on the substrate 500. The liquid 510 contacts the porous matrix where it is heated and changes to vapor 515 which rises through the liquid 510. Re-entrant cavities 520 serve as nucleation sites for vapor formation.

FIG. 8 illustrates on embodiment of a resistive heating element 600. The resistive heating element 600 has a heat generating substrate 605 surrounded by dielectric packing 610. The dielectric packing 610 is surrounded by a sheath 615 which has a heat transfer enhancement structure 620 on the heat conducting outer surface. The sheath 615 can be a non-porous tube or a non-porous tube with a porous metal layer on it.

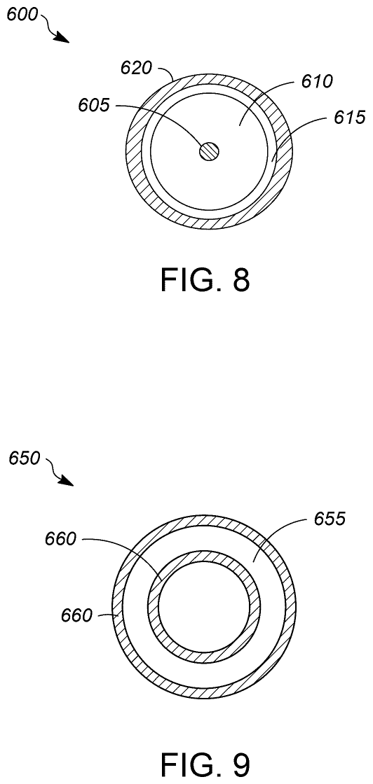

FIG. 9 illustrates one embodiment of an impedance heating element 650. The impedance heating element 650 has a hollow tube 655 made of solid metal or porous metal. On each side of the hollow tube 655 is a heat transfer enhancement structure 660. In some embodiments (not shown, rather than a tube, there is a solid rod. In this case, the heat transfer enhancement structure is on the outside of the rod.

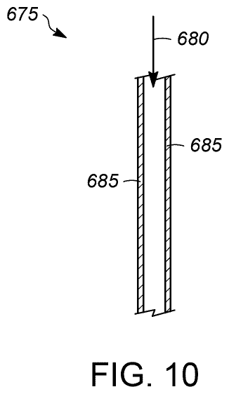

FIG. 10 illustrates one embodiment of an impedance heating plate 675. The solid metal or porous metal plate 680 has a heat transfer enhancement structure 685 on one or both surfaces. A resistive heating plate (not shown) would have a resistive wire surrounded by dielectric packing positioned between non-porous plates.

In some embodiments, the heat transfer enhancement structure comprises a patterned structure, or a mesh layer, or a porous particle layer, or combinations thereof, as illustrated in FIGS. 45A-D, 6A-B, and 7. In some embodiments, the patterned structure, or the mesh layer, or the porous particle layer, or combinations thereof has a substantially uniform porosity, while in other embodiments, the porosity at the heat conducting surface is less than the porosity at the opposite side (graded porosity).

In some embodiments, the mesh layer may comprise a single layer of mesh or more than one layer of mesh. When there are more than one layers, the layers of mesh could have the same porosity or different porosities. If the porosities of the layers are different, the porosity of the mesh layer at the heat conducting surface is typically less than the porosity on the opposite side of the layers of mesh, although this is not required.

In some embodiments, the porous particle layer may comprise more than one layer of porous particles.

In some embodiments, the porous particle layer comprises a mixture of metal particles and non-metal particles. In some embodiments, the metal particles comprise Cu, Cu alloys, Ti, Ti alloys, Ni, Ni alloys, NiCu alloys, Ni chrome alloys, FeCuAl FeCrAl alloys, Al, Al alloys, Fe, Fe alloys, W, W alloys, Mo, Mo alloys, Ag, Ag alloys, Au, Au alloys, Pt, Pt alloys, Zn, Zn alloys, brass, bronze, ferritic steel, austenitic steel, or combinations thereof, and the non-metal particles comprise diamond, and carbon-based materials or combinations thereof.

In some embodiments, the porous particle layer comprises a mixture of diamond and carbon-based materials. Carbon-based materials include, but are not limited to, graphene, graphene derivatives, fullerene, carbon nanotubes, carbon fibers, carbon dots embedded preferably uniaxially oriented within a metal copper or aluminum matrix.

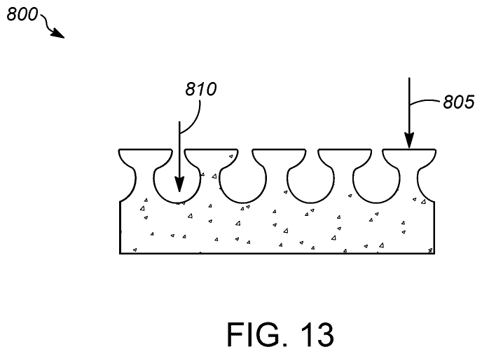

In some embodiments, as shown in FIG. 13, the heat transfer enhancement structure 800 has heterogenous wettability comprising a fluid phobic portion 805 and a fluid philic portion 810. The outermost wetted surface (the side opposite the heat conducting surface) having fluid-phobic portion 805 nature to encourage detachment of formed vapor bubbles and fluid-philic portion 810 below the outermost wetted surface to draw liquid in and increase vapor bubble nucleation.

In some embodiments, the heat conducting inner or outer surface or the porous metal comprises carbon steel, austenitic steel, ferritic steel, duplex stainless steel, chromium steel alloy, Ni, Ni alloy, Ni—Cr alloy, Ni—Cu alloy, Fe—Cr—Al alloy, Ti, Ti alloy, Al, Al alloy, Cu, Cu alloy, Pt, Pt alloy, Sn, Sn alloy, or combinations thereof.

In some embodiments, the heat transfer enhancement structure comprises carbon steel, austenitic steel, ferritic steel, duplex stainless steel, chromium steel alloy, Ni, Ni ally, Ni—Cr alloy, Ni—Cu alloy, Fe—Cr—Al alloy, Ti, Ti alloy, Al, Al alloy, Cu, Cu alloy, Pt, Pt alloy, Sn, Sn alloy, Ag, Ag alloy, Au, Au alloy, Fe, Fe alloy, Zn, Zn alloy, Ta, Ta alloys, Mo, Mo alloys, Zr, Zr alloys, brass, diamond, carbon-based materials a composite of metal and non-metal, or combinations thereof.

In some embodiments, the heat conducting outer surface of the electrical resistance heating element, the heat conducting outer surface of the rod or the heat conducting inner or outer surface of the non-porous or porous, hollow tube of the electrical impedance heating element comprises a different material from the heat transfer enhancement structure.

In other embodiments, the heat conducting outer surface of the electrical resistance heating element, the heat conducting outer surface of the rod or the heat conducting inner or outer surface of the non-porous or porous, hollow tube of the electrical impedance heating element comprises the same material as the heat transfer enhancement structure.

The electric heating elements can have any suitable shape. The electric heating elements can be circular or non-circular. Non-circular cross sections include ovals with two axes of symmetry, ovals with one axis of symmetry, an airfoil (or tear drop) with one axis of symmetry, triangular shape, rectangular shape, other regularly and irregularly shaped polygons. The electric heating elements can also be flat surfaces, plates, and the like. These non-circular cross-sectional configurations are believed to increase the effectiveness and efficiency of the heater by aligning, i.e., matching or tuning, the heat flux generated by the heating element to heat transfer coefficient around the circumference or perimeter of the electric heating element. Optionally, the heat conducting surface in contact with process fluid of one or more of the electric heating elements may be twisted with the twisted section exhibiting rotation about a central longitudinal axis. The electric heating elements may have some sections that are straight and others that are twisted.

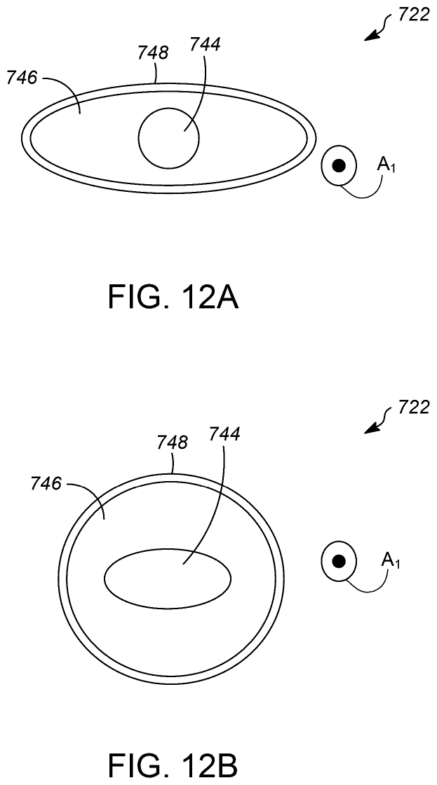

For electrical resistance heating elements, the sheath 748 may have, when viewed along the longitudinal axis, a non-circular cross section, and the heat generating substrate 744 may have, when viewed along the longitudinal axis, a circular cross section, as shown in FIG. 12A. Alternatively, the sheath 748 may have, when viewed along the longitudinal axis, a circular cross section, and the heat generating substrate 744 may have, when viewed along the longitudinal axis, a non-circular cross section, as shown in FIG. 12B. It is contemplated that a distance from an outer surface of the heat generating substrate to an inner surface of the sheath, when viewed along the longitudinal axis, is non-constant. For electrical impedance heating elements, the rods, porous tubes, or non-porous tubes, when viewed along the longitudinal axis, may have a circular cross section or a non-circular cross section.

In some embodiments, the heat conducting outer surface of the electrical resistance heating element, the heat conducting outer surface of the rod or the heat conducting inner or outer surface of the non-porous or porous hollow tube of the electrical impedance heating element is made of a porous metal.

In some embodiments, the heat transfer enhancement structure is connected to the heat conducting inner or outer surface. The heat transfer structure can be connected by any suitable process. The heat transfer enhancement structure can be formed in the inner or outer surface of the electric heating element by removing material from the surface or by adding material to the surface. The heat transfer enhancement structure may be formed separately and attached to the inner or outer surface of the electric heating element by welding, compression fitting, brazing, sintering, and the like. The porous particle layer can be deposited on the inner or outer surface of the electric heating element using processes known in the art.

It is anticipated that different manufacturing method may use depending on whether the element is of resistive type or impedance type, as well the type of surface enhancement. Some enhancements can be added to raw forms of pipe, tube or rod or porous metal formed of same that is used as conducting surface of the electrical heating element. Other enhancements can be added as part of finishing step such as coating the heat conducting surface with porous particle layer after resistive heating element has been formed. Regardless of enhancement, it would have be completed within the temperature capabilities, for example, any furnace brazing step to electric heating element.

It is also expected that other surface enhancements with other application methods but similar performance characteristics, such as a flame spray coating, could also provide electric heater designs with similar benefits as the example provided above.

Other manufacturing techniques for forming the heat transfer enhancement surface include, but are not limited to, brazing, sintering, flame spraying, screen printing, painting, knife coating, electrodeposition, laser etching, chemical etching, selective laser melting, selective laser sintering, direct metal laser sintering, chemical vapor deposition, hot dip coating, reactive ion/plasma etching, 3-D printing/additive manufacturing, turning, drilling, milling, grinding, laser ablation, electro discharge machining, grit blasting of the surface to created roughness, forging, extrusion, rolling, die-forming, drawing, explosive forming, die-casting, evaporative casting, and sand casting.

Another aspect of the invention is an electric heater for heating a fluid process stream. In one embodiment, the electric heater comprises a vessel having a fluid inlet and a fluid outlet, the vessel defining a cavity; a plurality of electric heating elements disposed in the cavity, the electric heating elements comprising electrical resistance heating elements or electrical impedance heating elements, or combinations thereof. The electrical resistance heating elements comprise: a heat generating substrate; a dielectric packing material surrounding the heat generating substrate; and a heat conducting outer surface wherein the heat conducting outer surface comprises a sheath comprising a non-porous, hollow tube having a heat transfer enhancement structure thereon, or a sheath comprising a non-porous, hollow tube with a porous metal layer on the surface with an optional heat transfer enhancement structure thereon. The electrical impedance heating elements comprise: a solid rod having a heat transfer enhancement structure on a heat conducting outer surface thereof, or a non-porous, hollow tube having a heat transfer enhancement structure on a heat conducting inner or outer surface thereof, or a non-porous, hollow tube with a porous metal layer on the surface with an optional heat transfer enhancement structure on a heat conducting inner or outer surface thereof.

The electric heater can used alone or in combination with one or more other heaters, such as fired boilers and the like.

In some embodiments, the plurality of electric heating elements are arranged in the same direction of flow of the fluid process stream. In other embodiments, the plurality of heating elements are arranged in a cross-flow configuration with a direction of flow of the fluid process stream. In this arrangement, the flow of the fluid process stream is perpendicular to the direction the electric heating elements are aligned.

The heat flux of the electrical heating elements may decrease in the direction of flow such that an electrical heating element closer to the fluid inlet has a higher heat flux compared to an electrical heating element farther from the inlet.

Zones of different heat flux may be applied to the entire heater. The heating element surface heat flux is throttled toward the outlet of the heater to keep the film temperature below the coking limit and/or minimize the chance of dry out from excessive vapor bubble formation at the heating surface of the element. The coking limit depends on the fluid being heated and can be determined by those skilled in the art.

It is contemplated that at least some of the electrical heating elements are configured to be operated independently of the remaining electrical heating elements. This will allow the heating duty of the elements to be different from each other and to create a heat flux which changes within the bundle.

For example, a heat flux of the electrical heating elements may generally decrease in the direction of flow such that electrical heating elements closer to the inlet end have a higher heating flux than those closer to the outlet end of the cavity. Even with an overall heat flux decreasing, it is possible that some electrical heating elements have a heat flux that is different from the overall heat flux trend.

In some embodiments, the plurality of electric heating elements are arranged in bundles. Two or more bundles may be controlled to generate substantially the same heat flux. Two or more of the bundles may be configured to be operated together (or non-independently) by the same controller. This may reduce the number of controllers needed to control large electric heaters with multiple bundles.

The electric heating elements can be arranged in an array. In some embodiments, the spacing between the electric heating elements in the bundle varies radially, or horizontally, or vertically, or combinations thereof. Combinations of circular, and non-circular heated surfaces placed at different orientations in the array can break-up the vapor film and minimize dry-out. The array of heating surfaces can be in a square pattern, a triangular pattern, or radial pattern, or combinations thereof. The square or triangular pattern can be inline or offset/staggered/rotated.

In some embodiments, the thermal resistance of the dielectric packing material in the electrical resistance heating element is constant in the longitudinal direction and in the azimuthal direction.

In some embodiments, the thermal resistance of the electrical impedance heating element is a constant in the longitudinal direction and in the azimuthal direction.

In some embodiments, the thermal resistance of the dielectric packing material in the electrical resistance heating element changes in the azimuthal direction.

In some embodiments, the thermal resistance of the electrical impedance heating element changes in the azimuthal direction.

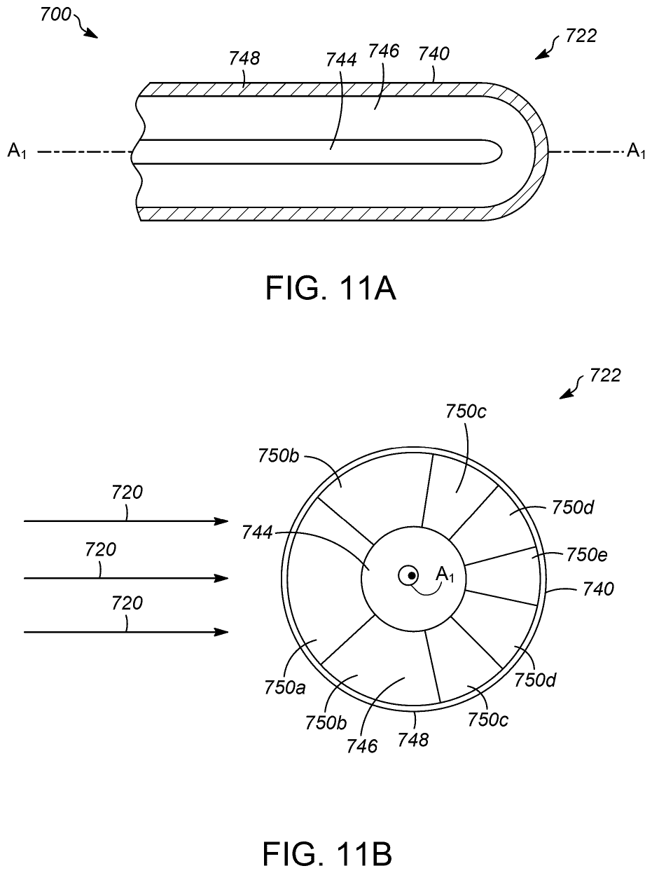

As shown in FIGS. 11A-B, the electric heater 700 comprises a heat generating substrate 744, dielectric packing material 746, and the sheath 748. In order to improve the effectiveness of the electric heater 700, the dielectric packing material 746 may be divided, when viewed along the longitudinal axis Al of the electrical heating element 722, into a plurality of thermal conductivity zones 750a, 750b, 750c, 750d, 750e with different thermal conductivity levels. The thermal conductivity zones 750a, 750b, 50c, 750d, 750e may be arranged to have an increasing thermal conductivity along the direction of flow 720. Thus, the thermal conductivity zones 750a proximate the outer surface 740 that is first contacted by the fluid (at the left of FIG. 111B) may have a relatively low thermal conductivity and as the fluid travels around the outer surface 740, the thermal conductivity of the thermal conductivity zones 750b, 750c, 750d, 750e may increase. Since the fluid can flow either on the upper or lower half, it is contemplated that the thermal conductivity zones 750a, 750b, 750c, 750d, 750e are arranged such that a horizontal cross section, when viewed along the longitudinal axis A1-A1, is a mirror image.

In some embodiments, the electric heater further comprises at least one bulk fluid temperature sensor in the vessel configured to obtain a temperature measurement associated with the bulk fluid in the vessel. In some embodiments, the electric heater further comprises at least one temperature sensor on one or more of the plurality of the electric heating elements, typically on the side of the heat transfer enhancement structure opposite the heat conducting outer surface (i.e., the wetting surface).

Further, the heater may be equipped with means, such as a sensor or probe, of determining a surface temperature of, for example, a sheathed heating element, which could be used to vary the current or voltage to the heating element in order to indirectly control the surface temperature of sheathed heating element.

At least one temperature sensor may be included in the electric heater. The temperature sensor may be configured to obtain a temperature measurement associated with the electric heater which may be temperature of the fluid at the inlet end at the outlet end, and/or a surface temperature of the outer surface of one or more of the electrical heating elements etc. The sensor may be in communication with a controller or computing devices or systems, which includes at least one processor and memory storing computer-readable instructions that, when executed by the at least one processor, cause the one or more computing devices to perform a process that may include one or more steps. For example, the one or more computing devices may be configured to receive, from the temperature sensor temperature data related to the electric heater. The controller may be configured to analyze the data. Based on analyzing the data, the controller may be configured to determine one or more recommended adjustments to one or more parameters associated with the electric heater including adjustment of a thermal flux of one or more electrical heating elements (or bundles thereof). The controller may be configured to transmit encrypted or unencrypted data that includes the one or more recommended adjustments to the electric heater including for example a flow rate associated with the electrical heater.

The electric heater can comprise a steam generator, or a reboiler, or a vaporizer, or an evaporator, or combinations thereof. The electric heating bundles can be oriented horizontally into a kettle vessel, in thermosiphons, or stabbed into columns. They can be oriented vertically and stabbed into the bottom of columns, or placed in a vertical section of piping external to the column to recirculate a reboiler fluid.

Another aspect of the invention is a method of heating a process fluid. In one embodiment, the method comprises passing the process fluid through an electric heater. The electric heater comprises a vessel having a fluid inlet and a fluid outlet, the vessel defining a cavity, a plurality of electric heating elements disposed in the cavity. The electric heating elements and various details concerning the electric heating elements have been described above.

In some embodiments, the plurality of electric heating elements are arranged in the same direction as the flow of the fluid process stream, while in other embodiments, a cross-flow configuration can be used.

In some embodiments, the heat flux generated by the plurality of electric heating elements decreases in the direction of flow of the fluid process stream.

In some embodiments, the heat flux generated by the plurality of electric heating elements is highest closest to the fluid inlet of the vessel.

In some embodiments, the plurality of electric heating elements are arranged vertically, the flow of the fluid process stream is vertical parallel to the electric heating elements, and the heat flux generated by the plurality of electric heating elements decreases in the direction of flow.

In some embodiments, the plurality of electric heating elements are arranged in bundles. In this case, at least two bundles are controlled to generate the substantially the same heat flux. Substantially the same heat flux means within plus or minus 20% of the total duty.

In some embodiments, the bundles have a circular cross section, while in others, the bundles have a non-circular cross section.

In some embodiments, the spacing between the electric heating elements in the bundle varies radially, or horizontally, or vertically, or combinations therof.

In some embodiments, the thermal resistance of the dielectric packing material in the electrical resistance heating element is constant in the longitudinal direction and in the azimuthal direction.

In some embodiments, the thermal resistance of the electrical impedance heating element is constant in the longitudinal direction and in the azimuthal direction.

In some embodiments, the thermal resistance of the dielectric packing material in the electrical resistance heating element changes in the azimuthal direction.

In some embodiments, the thermal resistance of the electrical impedance heating element changes in the azimuthal direction.

In some embodiments, the bulk fluid temperature is measured using a bulk fluid temperature sensor.

In some embodiments, the temperature at the side of the heat transfer enhancement structure opposite the heat conducting outer surface is measured using a temperature sensor.

For large reboiler duties, a reduction in the total number of electric heating elements required is usually possible, resulting in additional savings in piping, controls, foundation, and plot plan space.

For a vertical electrical heating element reboiler installed at bottom of distillation column, a reboiler using the electric heating elements of the present invention will have shorter length, reducing the height of the support skirt of distillation column which results in less metal being used and a lower foundation load, leading to lower capital expense.

Horizontal U-shaped bundle reboilers can be replaced by the electric heaters of the present invention.

The electric heaters and electric heating elements of the present invention can be used in a wide variety of applications, including, but not limited to, boilers, such as reboiler applications in refinery and petrochemical processes; amine purification processes, steam generators and steam boilers; distillation column reboilers; refrigerant vaporization; and other reboiler applications in the pharmaceutical, food and beverage, and brewery industries.

Electric heaters with the electrical resistance heating elements or electrical impedance heating elements of the present invention have unique capabilities that could enable the use of electric heaters in boiling services in addition to the currently limited set of applications, such as steam generators, water-glycol reboilers, certain low heat duty and low temperature boiling services. These electric heating elements significantly reduce the size and cost of an electric reboiler, while increasing the reliability.

The electric heaters and electric heating elements have a number of advantages. The high boiling heat transfer coefficient (HTC) removes heat from heated surfaces rapidly, reducing the surface temperature. Higher surface temperatures lead to fouling, coking, polymerization, gumming, etc., which increases the heated surface temperature. Higher boiling HTC would result in lower heated surface temperatures, allowing the use of lower grade metallurgy for the wetted surface, e.g., replacing stainless steel with carbon steel, reducing the cost of the system.

In addition, higher boiling HTC leads to a reduction in the required heated transfer surface area, which can result in fewer electric heating elements and/or fewer bundles of electric heating elements.

The reboilers are designed with low heat flux to stay in the nucleate boiling zone below the critical heat flux. It is desirable to operate many high power generation devices in nucleate boiling region to exploit the benefits of boiling phenomenon. However, the boiling process is limited by critical heat flux (CHF) exceeding of which results in reduced ability for dissipation of heat to surrounding fluid which may lead to material degradation of the heating element due to higher surface temperature, resulting in reduction of heat element life. Emerging demand for equipment intensification and effective thermal management requires much higher heat dissipation ability necessitating enhancement of the boiling heat transfer efficiency of the electric heating element. As shown in FIGS. 1A and 1B, the objective is to increase CHF and reduce wall superheat.

Replacement of a shell and tube reboiler with higher boiling HTC electrical heating elements allows reuse of the existing nozzle, kettle, and vessel, resulting in capital expense savings. Bare electrical heated elements can be replaced with higher boiling HTC electrical heating elements of higher overall heat transfer capability without changing the nozzle.

The structure of an enhanced porous surface improves wetting of the surface through capillary action and allows liquid circulation through the porous surface. The higher boiling HTC decreases the surface temperature which helps decrease fouling tendency. As the liquid is vaporized, the resulting gas bubbles grow and depart the surface. Growth of vapor bubbles, and liquid refilling of the pores after bubble departure, provides a natural pumping action which prevents surface “dry-out” and delays the onset of film boiling. Maximum critical heat flux (CHF) is increased by the porous enhanced surface.

A higher boiling HTC at each heat generating surface will allow use of fewer heating elements, or permit larger spacing between heating elements. This will increase flow area between heating elements, decreasing flow velocity and excitation forces (turbulent buffeting, shear velocity) to reduce vibrational potential.

For many chemical process applications, boiling of liquid is achieved on the shell side of shell and tube heat exchanger with the cold process liquid entering on the bottom side on shell and being vaporized as it flows upwards and over the array of tubes with the vapor exiting at the top of shell. Often steam is used as the heat transfer fluid on the tube side and is routed to each tube in roughly equal amounts (as function of design). This result in circumferentially uniform heat flux emanating from all tubes; however, the heat flux emanating from the tube may change in the longitudinal direction due to reduction in temperature and enthalpy. As liquid progressively boils, vapor bubbles form and surround the adjacent tubes (or rows of tubes), leading to a reduction in the heat transfer efficacy of the tubes. Therefore, the design must include a contingency for the limited effectiveness of the heating surface. This results in equipment design that is larger in footprint and higher in cost then it is required.

A method to control the heat flux of the heated surface to mitigate excessive vapor bubble blanketing may be included.

Additionally, the heated tube surface provides a constant heat flux circumferentially (azimuthally) by the nature of shell and tube heat exchanger design. Heat flux will boil liquid on shell side forming vapor bubbles initially on the incident side of heated surface. The bubbles detach and rise up to the liquid surface through the liquid. However, on the downstream side, there is less liquid but same heat flux, leading to large bubbles. Vapor blanketing on the downstream side of the tubes leads to a reduction in heat transfer efficacy. There is a benefit of tuning or aligning the heat flux circumferentially (azimuthally) around the electrical heating element. For example, a heating element in crossflow arrangement can have bimodal heat flux distribution where 0 degrees to 180 degrees (downstream side) has a lower heat flux compared to 180 degrees to 360 degrees (incident face). The heat flux in downstream side of heated surface can be controlled such that bubbles formed depart quickly and do not excessively blanket the heating elements or adjacent heating elements.

Additionally, the tube pitch or spacing of a shell and tube heat exchanger is generally constant. As a result, vapor bubbles created at the heated tube surfaces tend to coalesce and create a vapor blanket beyond just a single tube, forming a larger vapor pocket that will reduce the heat efficacy of the adjacent tube as well. As a result, there is increase pressure drop as the uniform tube pitch does not allow for increased vapor load. The coalescence of vapor bubbles formed at adjacent heat surfaces should be minimized to reduce the pressure drop resulting from increased vaporization. The heat flux of individual tubes or at least rows of tubes should be controlled to mitigate a vapor blanket of adjacent heated surfaces.

The boiling enhanced electric heating element of the present invention permits individual control of rows of heating elements or control of arrays of heating elements, where heat flux can be made to vary azimuthally around, and/or longitudinally around on an electric heating element by varying the electrical resistance or impedance of the heat element or the current or voltage to optimize boiling efficiency by minimizing vapor bubble blanketing of heat elements and to favor departure of vapor bubble on downstream side of heated element. The array of enhanced electrical heating elements have varying spacing to mitigate coalescence of the vapor bubbles from adjacent heated elements which will lead to dryout, and varying spacing to allow for increased vaporization of liquid so as not create excessive pressure drop. There may be a staggered arrangement of heating elements in the direction of increasing vaporization so as not to form a chimney of vapor bubbles that render an entire region of the heat element with reduced heat transfer efficiency.

The electric heaters and electrical heating elements can be used in many different applications, including, but not limited to, water boiling/steam generator, boiling multi-component non aqueous mixtures, boiling liquid mixture of aqueous and non-aqueous fluids, glycol and glycol water mix boiling, distillation column reboilers, amine regenerator reboilers, diethanolamine (DEA) and N-methyl diethanolamine (MDEA) stripper reboilers, acetic acid reboilers, benzene stripper reboilers, raffinate column reboilers, thermal oil steam generator feed-oxidate exchangers, CO₂ stripper reboilers, sea water/hydrocarbon vaporizers, HF stripper reboilers, cumene column overhead steam generators, column steam generators, de-ethanizer reboilers, de-propanizer reboilers, thermal desalination, brine concentration, and the like.

### SPECIFIC EMBODIMENTS

While the following is described in conjunction with specific embodiments, it will be understood that this description is intended to illustrate and not limit the scope of the preceding description and the appended claims.

A first embodiment of the invention is an apparatus for heating a fluid process stream comprising a vessel having a fluid inlet and a fluid outlet, the vessel defining a cavity; a plurality of electric heating elements disposed in the cavity, the electric heating elements comprising electrical resistance heating elements or electrical impedance heating elements, or combinations thereof; wherein the electrical resistance heating elements comprise; a heat generating substrate; a dielectric packing material surrounding the heat generating substrate; and a heat conducting outer surface wherein the heat conducting outer surface comprises a sheath comprising a non-porous, hollow tube having a heat transfer enhancement structure thereon; or a sheath comprising a non-porous hollow tube with a porous metal layer thereon, with an optional heat transfer enhancement structure thereon; or a solid flat plate having a heat transfer enhancement structure thereon, or a solid flat plate with a porous metal layer thereon, with an optional heat transfer enhancement structure thereon; and wherein the electrical impedance heating elements comprise a solid rod having a heat transfer enhancement structure on a heat conducting outer surface thereof; or a non-porous, hollow tube having a heat transfer enhancement structure on a heat conducting inner or outer surface thereof; or a porous, hollow tube with an optional heat transfer enhancement structure on a heat conducting inner or outer surface thereof; or a solid flat plate having a heat transfer enhancement structure on heat conducting surface thereof; or a porous, flat plate with an optional heat transfer enhancement structure on heat conducting surface thereof. An embodiment of the invention is one, any or all of prior embodiments in this paragraph up through the first embodiment in this paragraph wherein the heat transfer enhancement structure comprises a patterned structure, or a mesh layer, or a porous particle layer, or combinations thereof. An embodiment of the invention is one, any or all of prior embodiments in this paragraph up through the first embodiment in this paragraph wherein the heat transfer enhancement structure comprises the porous particle layer on the heat conducting inner or outer surface and wherein the porous particle layer has a substantially uniform porosity; or wherein the heat transfer enhancement structure comprises the porous particle layer on the heat conducting inner or outer surface and wherein the porous particle layer has a porosity at the heat conducting surface less than a porosity at the opposite side of the porous particle layer. An embodiment of the invention is one, any or all of prior embodiments in this paragraph up through the first embodiment in this paragraph wherein the heat transfer enhancement structure comprises the porous particle layer, and wherein the porous particle layer comprises a mixture of metal particles and non-metal particles, and wherein the metal particles comprise Cu, Cu alloys, Ti, Ti alloys, Ni, Ni alloys, NiCu alloys, Ni chrome alloys, FeCuAl FeCrAl alloys, Al, Al alloys, Fe, Fe alloys, W, W alloys, Mo, Mo alloys, Ag, Ag alloys, Au, Au alloys, Pt, Pt alloys, Zn, Zn alloys, Ta, Ta alloys, Mo, Mo alloys, Zr, Zr alloys, brass, bronze, ferritic steel, austenitic steel, or combinations thereof; and wherein the non-metal particles comprise diamond, and carbon-based materials or combinations thereof. An embodiment of the invention is one, any or all of prior embodiments in this paragraph up through the first embodiment in this paragraph wherein the heat conducting inner or outer surface or the porous metal comprises carbon steel, austenitic steel, ferritic steel, duplex stainless steel, chromium steel alloy, Ni, Ni alloy, Ni—Cr alloy, Ni—Cu alloy, Fe—Cr—Al alloy, Ti, Ti alloy, Al, Al alloy, Cu, Cu alloy, Pt, Pt alloy, Sn, Sn alloy, Ta, Ta alloy, Mo, Mo alloy, Zr, Zr alloy, or combinations thereof. An embodiment of the invention is one, any or all of prior embodiments in this paragraph up through the first embodiment in this paragraph wherein the heat transfer enhancement structure comprises carbon steel, austenitic steel, ferritic steel, duplex stainless steel, chromium steel alloy, Ni, Ni ally, Ni—Cr alloy, Ni—Cu alloy, Fe—Cr—Al alloy, Ti, Ti alloy, Al, Al alloy, Cu, Cu alloy, Pt, Pt alloy, Sn, Sn alloy, Ag, Ag alloy, Au, Au alloy, Fe, Fe alloy, Zn, Zn alloy, Ta, Ta alloy, Mo, Mo alloy, Zr, Zr alloy, brass, diamond, carbon-based materials, a composite of metal and non-metal, or combinations thereof. An embodiment of the invention is one, any or all of prior embodiments in this paragraph up through the first embodiment in this paragraph wherein the heat conducting outer surface of the electrical resistance heating element, the heat conducting outer surface of the rod, or the heat conducting inner or outer surface of the non-porous or porous hollow tube of the electrical impedance heating element comprises a different material from the heat transfer enhancement structure or the same material as the heat transfer enhancement structure. An embodiment of the invention is one, any or all of prior embodiments in this paragraph up through the first embodiment in this paragraph wherein the electric heating element has a circular cross section or a non-circular cross section. An embodiment of the invention is one, any or all of prior embodiments in this paragraph up through the first embodiment in this paragraph wherein the plurality of electric heating elements are arranged in a co-current or countercurrent configuration with a direction of flow of the fluid process stream, or wherein the plurality of electric heating elements are arranged in a cross-flow configuration with a direction of flow of the fluid process stream. An embodiment of the invention is one, any or all of prior embodiments in this paragraph up through the first embodiment in this paragraph wherein a heat flux generated by the plurality of electric heating elements decreases in the direction of fluid flow. An embodiment of the invention is one, any or all of prior embodiments in this paragraph up through the first embodiment in this paragraph wherein the plurality of electric heating elements are arranged in bundles and wherein at least two bundles are controlled to generate substantially the same heat flux. An embodiment of the invention is one, any or all of prior embodiments in this paragraph up through the first embodiment in this paragraph wherein the bundles have a circular cross section, or wherein the bundles have a non-circular cross section. An embodiment of the invention is one, any or all of prior embodiments in this paragraph up through the first embodiment in this paragraph wherein a spacing between the electric heating elements in the bundle varies radially, or horizontally, or vertically, or combinations thereof. An embodiment of the invention is one, any or all of prior embodiments in this paragraph up through the first embodiment in this paragraph wherein a thermal resistance of the dielectric packing material in the electrical resistance heating element is constant in the longitudinal direction and in the azimuthal direction. An embodiment of the invention is one, any or all of prior embodiments in this paragraph up through the first embodiment in this paragraph wherein a thermal resistance of the dielectric packing material in the electrical resistance heating element changes in the azimuthal direction. An embodiment of the invention is one, any or all of prior embodiments in this paragraph up through the first embodiment in this paragraph further comprising a bulk fluid temperature sensor in the vessel; or a temperature sensor on one or more of the plurality of the electric heating elements; or both. An embodiment of the invention is one, any or all of prior embodiments in this paragraph up through the first embodiment in this paragraph wherein the electric heater comprises a steam generator, or a reboiler, or a vaporizer, or an evaporator, or combinations thereof.

A second embodiment of the invention is a composition comprising an electrical resistance heating element or an electrical impedance heating element; wherein the electrical resistance heated element comprises a heat generating substrate; a dielectric packing material surrounding the heat generating substrate; and a heat conducting outer surface wherein the heat conducting outer surface comprises a sheath comprising a non-porous, hollow tube having a heat transfer enhancement structure thereon; or a sheath comprising a non-porous hollow tube with a porous metal layer thereon with an optional heat transfer enhancement structure thereon; or a solid flat plate having a heat transfer enhancement structure thereon, or a solid flat plate with a porous metal layer thereon, with an optional heat transfer enhancement structure thereon; and wherein the electrical impedance heated element comprises a solid rod having a heat transfer enhancement structure on a heat conducting outer surface thereof; or a non-porous, hollow tube having a heat transfer enhancement structure on a heat conducting inner or outer surface thereof; or a porous hollow tube with an optional heat transfer enhancement structure on a heat conducting inner or outer surface thereof; or a solid flat plate having a heat transfer enhancement structure on heat conducting surface thereof; or a porous, flat plate with an optional heat transfer enhancement structure on heat conducting surface thereof. An embodiment of the invention is one, any or all of prior embodiments in this paragraph up through the second embodiment in this paragraph wherein the heat transfer enhancement structure comprises a porous particle layer and wherein the porous particle layer has a substantially uniform porosity; or wherein the heat transfer enhancement structure comprises the porous particle layer and wherein the porous particle layer has a porosity at the heat conducting surface less than a porosity at the opposite side of the porous particle layer.

A third embodiment of the invention is a method of heating a process fluid comprising passing the process fluid through an electric heater comprising a vessel having a fluid inlet and a fluid outlet, the vessel defining a cavity; a plurality of electric heating elements disposed in the cavity, the electric heating elements comprising electrical resistance heating elements or electrical impedance heating elements, or combinations thereof, wherein the electrical resistance heating elements comprise; a heat generating substrate; a dielectric packing material surrounding the heat generating substrate; and a heat conducting outer surface wherein the heat conducting outer surface comprises a sheath comprising a non-porous, hollow tube having a heat transfer enhancement structure thereon; or a sheath comprising a non-porous hollow tube with a porous metal layer thereon, with an optional heat transfer enhancement structure thereon; or a solid flat plate having a heat transfer enhancement structure thereon, or a solid flat plate with a porous metal layer thereon, with an optional heat transfer enhancement structure thereon; and wherein the electrical impedance heating elements comprise a solid rod having a heat transfer enhancement structure on a heat conducting outer surface thereof; or a non-porous, hollow tube having a heat transfer enhancement structure on a heat conducting inner or outer surface thereof; or a porous hollow tube with an optional heat transfer enhancement structure on a heat conducting inner or outer surface thereof; or a solid flat plate having a heat transfer enhancement structure on heat conducting surface thereof; or a porous, flat plate with an optional heat transfer enhancement structure on heat conducting surface thereof.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

What is claimed is:

1. An electric heater for heating a fluid process stream comprising:
a vessel having a fluid inlet and a fluid outlet, the vessel defining a cavity;
a plurality of electric heating elements disposed in the cavity, the electric heating elements comprising electrical resistance heating elements or electrical impedance heating elements, or combinations thereof;
wherein the electrical resistance heating elements comprise;
a heat generating substrate;
a dielectric packing material surrounding the heat generating substrate; and
a heat conducting outer surface wherein the heat conducting outer surface comprises a sheath comprising a non-porous, hollow tube having a heat transfer enhancement structure thereon; or a sheath comprising a non-porous hollow tube with a porous metal layer thereon, with an optional heat transfer enhancement structure thereon; or a solid flat plate having a heat transfer enhancement structure thereon, or a solid flat plate with a porous metal layer thereon, with an optional heat transfer enhancement structure thereon;
and
wherein the electrical impedance heating elements comprise:
a solid rod having a heat transfer enhancement structure on a heat conducting outer surface thereof; or a non-porous, hollow tube having a heat transfer enhancement structure on a heat conducting inner or outer surface thereof; or a porous, hollow tube with an optional heat transfer enhancement structure on a heat conducting inner or outer surface thereof; or a solid flat plate having a heat transfer enhancement structure on heat conducting surface thereof; or a porous, flat plate with an optional heat transfer enhancement structure on heat conducting surface thereof.

2. The electric heater of claim 1 wherein the heat transfer enhancement structure comprises a patterned structure, or a mesh layer, or a porous particle layer, or combinations thereof.

3. The electric heater of claim 2:
wherein the heat transfer enhancement structure comprises the porous particle layer on the heat conducting inner or outer surface and wherein the porous particle layer has a substantially uniform porosity; or
wherein the heat transfer enhancement structure comprises the porous particle layer on the heat conducting inner or outer surface and wherein the porous particle layer has a porosity at the heat conducting surface less than a porosity at the opposite side of the porous particle layer.

4. The electric heater of claim 2 wherein the heat transfer enhancement structure comprises the porous particle layer, and wherein the porous particle layer comprises a mixture of metal particles and non-metal particles, and wherein the metal particles comprise Cu, Cu alloys, Ti, Ti alloys, Ni, Ni alloys, NiCu alloys, Ni chrome alloys, FeCuAl FeCrAl alloys, Al, Al alloys, Fe, Fe alloys, W, W alloys, Mo, Mo alloys, Ag, Ag alloys, Au, Au alloys, Pt, Pt alloys, Zn, Zn alloys, Ta, Ta alloys, Mo, Mo alloys, Zr, Zr alloys brass, bronze, ferritic steel, austenitic steel, or combinations thereof; and wherein the non-metal particles comprise diamond, and carbon-based materials or combinations thereof.

5. The electric heater of claim 1 wherein the heat conducting inner or outer surface or the porous metal comprises carbon steel, austenitic steel, ferritic steel, duplex stainless steel, chromium steel alloy, Ni, Ni alloy, Ni—Cr alloy, Ni—Cu alloy, Fe—Cr—Al alloy, Ti, Ti alloy, Al, Al alloy, Cu, Cu alloy, Pt, Pt alloy, Sn, Sn alloy, Ta, Ta alloy, Mo, Mo alloy, Zr, Zr alloy, or combinations thereof.

6. The electric heater of claim 1 wherein the heat transfer enhancement structure comprises carbon steel, austenitic steel, ferritic steel, duplex stainless steel, chromium steel alloy, Ni, Ni ally, Ni—Cr alloy, Ni—Cu alloy, Fe—Cr—Al alloy, Ti, Ti alloy, Al, Al alloy, Cu, Cu alloy, Pt, Pt alloy, Sn, Sn alloy, Ag, Ag alloy, Au, Au alloy, Fe, Fe alloy, Zn, Zn alloy, Ta, Ta alloy, Mo, Mo alloy, Zr, Zr alloy, brass, diamond, carbon-based materials, a composite of metal and non-metal, or combinations thereof.

7. The electric heater of claim 1 wherein the heat conducting outer surface of the electrical resistance heating element, the heat conducting outer surface of the rod, or the heat conducting inner or outer surface of the non-porous or porous hollow tube of the electrical impedance heating element comprises a different material from the heat transfer enhancement structure or the same material as the heat transfer enhancement structure.

8. The electric heater of claim 1 wherein the electric heating element has a circular cross section or a non-circular cross section.

9. The electric heater of claim 1 wherein the plurality of electric heating elements are arranged in a co-current or countercurrent configuration with a direction of flow of the fluid process stream, or wherein the plurality of electric heating elements are arranged in a cross-flow configuration with a direction of flow of the fluid process stream.

10. The electric heater of claim 1 wherein a heat flux generated by the plurality of electric heating elements decreases in the direction of fluid flow.

11. The electric heater of claim 1 wherein the plurality of electric heating elements are arranged in bundles and wherein at least two bundles are controlled to generate substantially the same heat flux.

12. The electric heater of claim 11 wherein the bundles have a circular cross section, or wherein the bundles have a non-circular cross section.

13. The electric heater of claim 11 wherein a spacing between the electric heating elements in the bundle varies radially, or horizontally, or vertically, or combinations thereof.

14. The electric heater of claim 1 wherein a thermal resistance of the dielectric packing material in the electrical resistance heating element is constant in the longitudinal direction and in the azimuthal direction.

15. The electric heater of claim 1 wherein a thermal resistance of the dielectric packing material in the electrical resistance heating element changes in the azimuthal direction.

16. The electric heater of claim 1 further comprising:
a bulk fluid temperature sensor in the vessel; or
a temperature sensor on one or more of the plurality of the electric heating elements;
or both.

17. The electric heater of claim 1 wherein the electric heater comprises a steam generator, or a reboiler, or a vaporizer, or an evaporator, or combinations thereof.

18. An electric heating element comprising:
an electrical resistance heating element or an electrical impedance heating element;
wherein the electrical resistance heated element comprises:
a heat generating substrate;
a dielectric packing material surrounding the heat generating substrate; and
a heat conducting outer surface wherein the heat conducting outer surface comprises a sheath comprising a non-porous, hollow tube having a heat transfer enhancement structure thereon; or a sheath comprising a non-porous hollow tube with a porous metal layer thereon with an optional heat transfer enhancement structure thereon; or a solid flat plate having a heat transfer enhancement structure thereon, or a solid flat plate with a porous metal layer thereon, with an optional heat transfer enhancement structure thereon;
and
wherein the electrical impedance heated element comprises:
a solid rod having a heat transfer enhancement structure on a heat conducting outer surface thereof; or a non-porous, hollow tube having a heat transfer enhancement structure on a heat conducting inner or outer surface thereof; or a porous hollow tube with an optional heat transfer enhancement structure on a heat conducting inner or outer surface thereof; or a solid flat plate having a heat transfer enhancement structure on heat conducting surface thereof; or a porous, flat plate with an optional heat transfer enhancement structure on heat conducting surface thereof.

19. The electric heating element of claim 18 wherein the heat transfer enhancement structure comprises a porous particle layer and wherein the porous particle layer has a substantially uniform porosity; or
wherein the heat transfer enhancement structure comprises the porous particle layer and wherein the porous particle layer has a porosity at the heat conducting surface less than a porosity at the opposite side of the porous particle layer.

20. A method of heating a process fluid comprising:
passing the process fluid through an electric heater comprising:
a vessel having a fluid inlet and a fluid outlet, the vessel defining a cavity;
a plurality of electric heating elements disposed in the cavity, the electric heating elements comprising electrical resistance heating elements or electrical impedance heating elements, or combinations thereof;
wherein the electrical resistance heating elements comprise;
a heat generating substrate;
a dielectric packing material surrounding the heat generating substrate; and
a heat conducting outer surface wherein the heat conducting outer surface comprises a sheath comprising a non-porous, hollow tube having a heat transfer enhancement structure thereon; or a sheath comprising a non-porous hollow tube with a porous metal layer thereon, with an optional heat transfer enhancement structure thereon; or a solid flat plate having a heat transfer enhancement structure thereon, or a solid flat plate with a porous metal layer thereon, with an optional heat transfer enhancement structure thereon;
and
wherein the electrical impedance heating elements comprise:
a solid rod having a heat transfer enhancement structure on a heat conducting outer surface thereof; or a non-porous, hollow tube having a heat transfer enhancement structure on a heat conducting inner or outer surface thereof; or a porous hollow tube with an optional heat transfer enhancement structure on a heat conducting inner or outer surface thereof; or a solid flat plate having a heat transfer enhancement structure on heat conducting surface thereof; or a porous, flat plate with an optional heat transfer enhancement structure on heat conducting surface thereof.
